(19) United States
(12) Patent Application Publication
(10) Pub. No.: US 2012/0254443 A1
(43) Pub. Date: Oct. 4, 2012

(54) INFORMATION PROCESSING SYSTEM, INFORMATION PROCESSING APPARATUS, METHOD OF SCALING, PROGRAM, AND RECORDING MEDIUM

(75) Inventor: Yohei Ueda, Yamato (JP)

(73) Assignee: International Business Machines Corporation, Armonk, NY (US)

(21) Appl. No.: 13/435,037

(22) Filed: Mar. 30, 2012

(30) Foreign Application Priority Data
Mar. 30, 2011 (JP) 2011-074519

(51) Int. Cl. G06F 15/173

(52) U.S. Cl. 709/226

(57) ABSTRACT

An information processing system 100 includes a processing server group 120 including processing servers 122; an alternate server 124 for responding to requests on behalf of the processing server group 120; and a load balancer 110 distributing traffic within the processing server group 120 and, when the processing server group 120 is overloaded, transferring traffic to the alternate server 124. The information processing system 100 further calculates a target size of the processing server group 120 on the basis of the amount of traffic transferred by the load balancer 110 to the processing server group 120 and the amount of traffic transferred by the load balancer 110 to the alternate server 124, and prepares the processing servers in the processing server group in order to increase the size of the processing server group to the target size.

### FIELD OF THE INVENTION

The present invention relates to an auto-scaling mechanism in a cloud environment. More specifically, the present invention relates to an information processing system, an information processing apparatus, a method of scaling, a program, and a recording medium that implement an auto-scaling mechanism for increasing or decreasing the server size in response to changes in demand.

### BACKGROUND OF THE INVENTION

With developments in system virtualization technologies and advances in Internet technologies, a cloud service called IaaS (Infrastructure as a Service) has become widespread in recent years. Through IaaS, infrastructures such as virtual machines are provided as a service over the Internet. IaaS allows a cloud user to increase or decrease the number of web server instances in a timely manner in response to the number of accesses. This leads to providing a system capable of promptly expanding or reducing its ability to meet changes in demand.

While increasing or decreasing the number of instances as above can be manually achieved by a cloud user by predicting a required ability from the demand situation under an operator's monitoring, auto-scaling techniques are also known. In auto-scaling techniques, certain trigger conditions are set to automatically increase or decrease the number of instances. For example, in Amazon EC2®, a cloud service provided by Amazon.com, Inc., a cloud user can condition the increase or decrease of the number of virtual machine instances by defining rules using an observable evaluation index (metric) such as the average CPU utilization rate (non-patent document 1). According to auto-scaling functions of this conventional technique, for example, a cloud user can define a rule such that a fixed number of instances are added if the average CPU utilization rate is above 80%, and a fixed number of instances are removed if the average CPU utilization rate is below 20%. Evaluation indices used for trigger conditions are not limited to the average CPU utilization rate but may include various metrics, such as the memory utilization rate, the degree of disk utilization, and the network flow rate (“Nifty Cloud Service Plan”, [Online], cloud top, service plan, service specifications, [retrieved on Dec. 6, 2010], the Internet at the cloud.nifty web site page service/spec.htm).

Known auto-scaling techniques are broadly divided into reactive scaling as described above and proactive scaling. Reactive scaling increases or decreases the scale in response to demands, whereas proactive scaling proactively adjusts the number of server instances by statistically computing predicted demands from past records.

A conventional technique related to proactive scaling is Japanese Patent Laid-Open No. 2008-129878. The Japanese Patent Laid-Open No. 2008-129878, aiming to quantitatively predict processing performance required in each server group for business requirements, discloses a technique in a system for predicting performance of a business processing system having three layers, including a front-end server group, a middle server group, and a back-end server group. The system is provided with: a required processing capability calculation unit that receives additional business requirements to be processed by the business processing system and predicts the processing time required for the middle server group to process the business requirements; and a server quantity calculation unit that calculates the number of required server machines of the backend server group on the basis of the predicted processing time.

Further, as a scaling technique using past history information, a International Publication No. WO2007/034826 discloses a technique including: calculating a throughput change based on a response time monitoring result, a response time target value, a quantity model, and performance specification information; sequentially assigning the performance specification information to the obtained quantity model to calculate a throughput for each pool server; selecting a pool server corresponding to a throughput indicating a value greater than and closest to the throughput change; instructing to perform configuration modification control for the selected pool server; and modifying a configuration so that the pool server functions as an application server.

### SUMMARY OF THE INVENTION

Unfortunately, with reactive scaling as described above, although slow changes in demand can be addressed to increase or decrease the number of virtual machine instances, rapid changes in demand are hard to be addressed. Also, if thresholds for a metric are used to increase or decrease the number of instances as described above, using scale units of fixed numbers of instances prevents flexibly addressing changes in demand. It might be possible to use scale units of variable numbers of instances depending on the load. However, the throughput of overloaded servers no more increase, so that metrics such as the average CPU utilization rate and the network flow rate are saturated, making it difficult to estimate the number of instances to be added to meet the demands. Therefore, in conventional reactive scaling, instances are activated step by step through monitoring up to an ultimately required number of instances, while repeating a cycle of satisfaction of a trigger condition, activation of a certain number of server instances, and monitoring of the trigger condition after completion of the activation. This may cause a delay corresponding to the time it takes to activate the instances, failing in keeping up with changes in demand.

As disclosed in the patent document 2, demands may be predicted by using history information. However, changes in demand beyond past records cannot be addressed. Proactive scaling also cannot address changes in demand beyond prediction because it proactively predicts demands from past records. For example, for a sudden load concentration on a website such as at the time of disaster, it is desirable to accurately quantify the demands and immediately prepare a required number of instances. Unfortunately, the above conventional techniques cannot sufficiently address a sudden unexpected change in demand.

An object of the present invention, which has been made in view of the shortcomings with the above conventional techniques, is to provide an information processing system, an information processing apparatus, a method of scaling, a program, and a recording medium that implement an auto-scaling mechanism capable of increasing the server size in response to even a sudden unexpected change in demand.

To solve the above problems, the present invention provides an information processing system and an information processing apparatus having the following features. The information processing system includes: a processing server group including a plurality of processing servers; an alternate server for responding to requests on behalf of the processing server group; and a load balancer distributing traffic among the processing servers in the processing server group and transferring traffic to the alternate server on condition that the processing server group becomes overloaded. The information processing apparatus in the information processing system calculates a target size of the processing server group on the basis of the amount of traffic transferred by the load balancer to the processing server group and the amount of traffic transferred by the load balancer to the alternate server, and prepares the processing servers in order to increase the size of the processing server group to the target size.

Further, according to the present invention, calculating the target size of the processing server group may depend on an evaluation index representing a local load observed for the processing servers in the processing server group. The information processing system may further include a second server group provided in a stage following the processing server group. The system may determine a bottleneck from the evaluation index observed for the processing servers in the processing server group and on condition that it is determined that the bottleneck is in the stage following the processing server group, calculate a target size of the second server group on the basis of the amount of traffic transferred to the processing server group and the amount of traffic transferred to the alternate server, and prepare processing servers in the second server group. The load balancer may monitor response performance of the processing server group, and determine that the processing server group is overloaded on condition that the response performance satisfies a transfer condition. Calculating the target size of the processing server group on the basis of the amounts of transferred traffic and preparing the processing servers in order to increase the size to the target size may be triggered by satisfaction of the same condition as the transfer condition. The present invention can further provide a method of scaling performed in the information processing system, a program for implementing the information processing apparatus, and a recording medium having the program stored thereon.

With the above configuration, demands in a web system are quantified on the basis of the amount of traffic transferred by the load balancer to the processing server group and the amount of traffic transferred by the load balancer to the alternate server. This enables accurately quantifying potential demands in the system, leading to promptly addressing an unexpected change in demand.

### BRIEF DESCRIPTION OF THE DRAWINGS

FIG. 1 is a schematic diagram of a provisioning system according to an embodiment of the present invention;

FIG. 2 is a block diagram showing a hardware configuration and a software configuration of a physical host machine in the provisioning system according to an embodiment of the present invention;

FIG. 3 is a functional block diagram related to an auto-scaling mechanism in response to changes in demand, implemented in the provisioning system according to an embodiment of the present invention;

FIG. 4 is a diagram illustrating a management screen for making auto-scaling settings provided by a management portal in the provisioning system according to an embodiment of the present invention;

FIG. 5 is a flowchart showing an auto-scaling process in response to changes in demand, implemented in the provisioning system according to an embodiment of the present invention;

FIG. 6 is a flowchart (1/2) showing another auto-scaling process in response to changes in demand, implemented in the provisioning system according to an embodiment of the present invention;

FIG. 7 is the flowchart (2/2) showing the other auto-scaling process in response to changes in demand, implemented in the provisioning system according to an embodiment of the present invention;

FIG. 8 is a diagram for describing the case of scaling a web system that employs another multi-layered architecture configuration in the provisioning system according to an embodiment of the present invention; and

FIG. 9 is a graph showing changes over time in the number of web server instances according to auto-scaling in a conventional technique.

### DETAILED DESCRIPTION OF THE DRAWINGS

While the present invention will be described below with respect to its embodiments, the present invention is not limited to the embodiments described below. In the embodiments described below, a provisioning system that implements an auto-scaling mechanism for virtual machines running on physical host machines will be described as the information processing system. In the following description, cases of using the provisioning system according to embodiments of the present invention to scale a web system having a multi-layered architecture will be described.

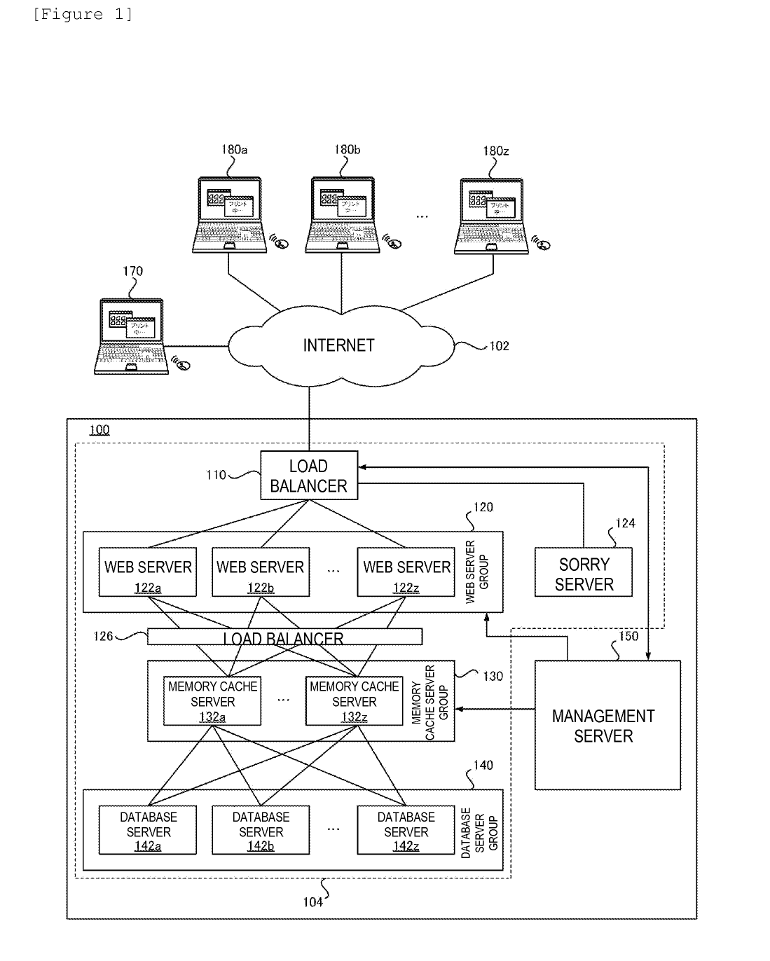

FIG. 1 shows a schematic diagram of a provisioning system according to an embodiment of the present invention. In a provisioning system 100 shown in FIG. 1, a web system 104 providing services to end users over the Internet 102 is constructed as a virtual computing system on physical resources (not shown). The web system 104 includes: a load balancer 110; a web server group 120 that is assigned traffic by the load balancer 110 and processes requests sent from the end users' client terminals 180 over the Internet 102; and a Sorry server 124 that responds to requests on behalf of the web server group 120 when the web server group 120 is overloaded. The web system 104 shown in FIG. 1 employs a multi-layer architecture configuration, in which a memory cache server group 130 is provided in a stage following the web server group 120 and is assigned traffic from the web server group 120 by a load balancer 126, and a database server group 140 is provided in a stage following the memory cache server group 130.

Web servers 122a to 122z forming the web server group 120, memory cache servers 132a to 132z forming the memory cache server group 130, and database servers 142a to 142z forming the database server group 140 are each implemented as a virtual machine (virtual server) running on a physical host machine (not shown). Each physical host machine includes hardware resources such as a processor and memory. Virtualization software installed in the physical host machine abstracts these hardware resources, on which virtualized computers, i.e., virtual machines are implemented. The physical host machines are interconnected via a LAN (Local Area Network) based on TCP/IP or Ethernet® or via a wide area network configured over a public line through a dedicated line or a VPN (Virtual Private Network), and provide a resource pool as a whole.

The load balancers 110 and 126 are provided as physical load distribution devices, or as software on the virtual machines providing load distribution functions. Similarly, the Sorry server 124 is provided as a physical server device, or as software on the virtual machines providing Sorry server functions. While the Sorry server 124 is described as an independent module in the embodiment shown in FIG. 1, the Sorry server 124 may be implemented as part of functions provided by the load balancer 110 or as part of functions provided by any of the web servers 122.

The provisioning system 100 further includes a management server 150. The management server 150 provides a management portal site for using services to an operator on the cloud user's side (hereinafter simply referred to as a cloud user). The management server 150 has a management application for processing various management requests issued by the cloud user through the management portal site. The management application collects information on a virtual computing environment constructed on physical resources, manages various settings, and responds to requests from the cloud user to remotely manage the virtualization software running on the physical host machines. The virtual server instances 122, 132, and 142, the Sorry server 124, and the load balancers 110 and 126 are managed by the management server 150.

The cloud user uses a management terminal 170 to access the management server 150 via the Internet 102, selects a pre-provided OS image in the management portal site for a service in question, and requests provisioning. Thus, the cloud user can activate instances of the web servers 122, the memory cache servers 132, and the database servers 142. Through the management portal site, the cloud user can also register instances (or a group of instances) among which load is to be distributed by the load balancers 110 and 126, register an alternate server to which traffic is to be transferred, and make auto-scaling settings for conditioning the increase or decrease of the number of instances of the web servers 122 or the memory cache servers 132.

Generally, the management server 150 is configured as a general-purpose computer device, such as a workstation, a rack-mount server, or a blade server. More specifically, the management server 150 includes hardware resources, including a central processing unit (CPU) such as a single-core processor or a multi-core processor, cache memory, RAM (Random Access Memory), a network interface card (NIC), and a storage device. The management server 150 provides functions as a management interface for a virtualized environment under the control of an appropriate OS such as Windows®, UNIX®, or LINUX®. Alternatively, the management server 150 may be implemented as a virtual machine running on the physical host machines.

Generally, the management terminal 170 and the client terminals 180a to 180z are each configured as a computer device, such as a tower, desk-top, lap-top, or tablet personal computer, workstation, net book, or PDA (Personal Digital Assistance). Each terminal includes hardware resources as described above, such as a CPU, and operates under the control of an appropriate OS such as Windows®, UNIX®, LINUX®, Mac OS®, or AIX®. In this embodiment, the management terminal 170 and the client terminals 180a to 180z each implements a web browser running on the OS and is provided with the management portal site and services through the web browser.

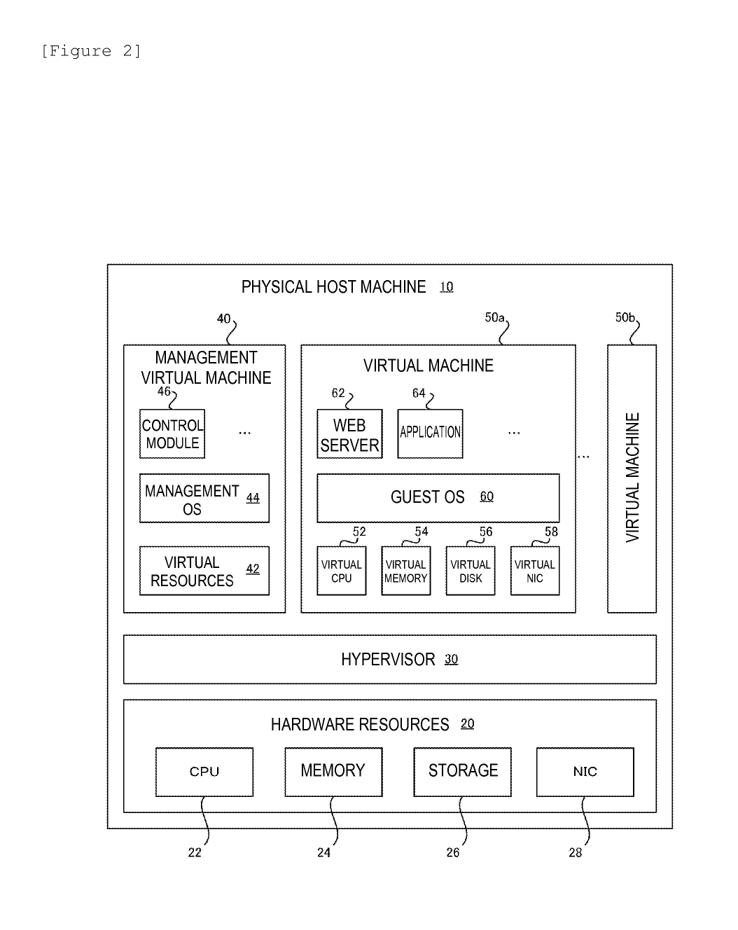

A configuration of a physical host machine that runs the virtual machines such as the web servers 122 and the memory cache servers 132 will be described below. FIG. 2 is a block diagram showing a hardware configuration and a software configuration of the physical host machine in the provisioning system according to an embodiment of the present invention. Generally, the physical host machine 10 is configured as a general-purpose computer device, such as a workstation, a rack-mount server, a blade server, a mid-range computer, or a mainframe computer. As hardware resources 20, the physical host machine 10 includes a CPU 22, a memory 24, a storage 26 such as a hard disk drive (HDD) or a solid state drive (SSD), and an NIC 28.

The physical host machine 10 includes a hypervisor (which may also be called a virtual-machine monitor) 30 for virtualization software such as Xen®, VMWare®, or Hyper-V®, running on the hardware resources 20. Running on the hypervisor 30 are virtual machines 40 and 50, which has various OSs as guest OSs, such as Windows®, UNIX®, and LINUX®.

The virtual machine 40 is a management virtual machine called a domain 0 or a parent partition, and includes virtual resources 42, a management OS 44, and a control module 46 running on the management OS 44. The control module 46 is a module that receives an instruction from the management server 150 and issues a command to the hypervisor 30 on the physical host machine 10 in which the control module 46 runs. The control module 46 responds to an instruction from the management server 150 to issue an instruction to the hypervisor 30 to create a user-domain virtual machine called a domain U or a child partition or activate the guest OSs, and controls the operation of the virtual machine under the control of the management server 150.

The virtual machines 50a and 50b are user-domain virtual machines that provide computing capabilities to the cloud user. Each virtual machine 50 includes: virtual resources such as a virtual CPU 52, a virtual memory 54, a virtual disk 56, and a virtual NIC 58; a guest OS 60; and various applications 62 and 64 running on the guest OS 60. The applications depend on the cloud user and may be in various combinations. If the virtual machines 50 are operated as the web servers 122, an application that provides web server functions runs, such as Apache HTTP Server® or Internet Information Services®. If the virtual machines 50 are operated as the memory cache servers 132, an application that provides distributed memory cache functions runs, such as memcached. If the virtual machines 50 are operated as the database servers 142, an application that provides database functions runs, such as DB2®, MySQL®, or PostgreSQL®.

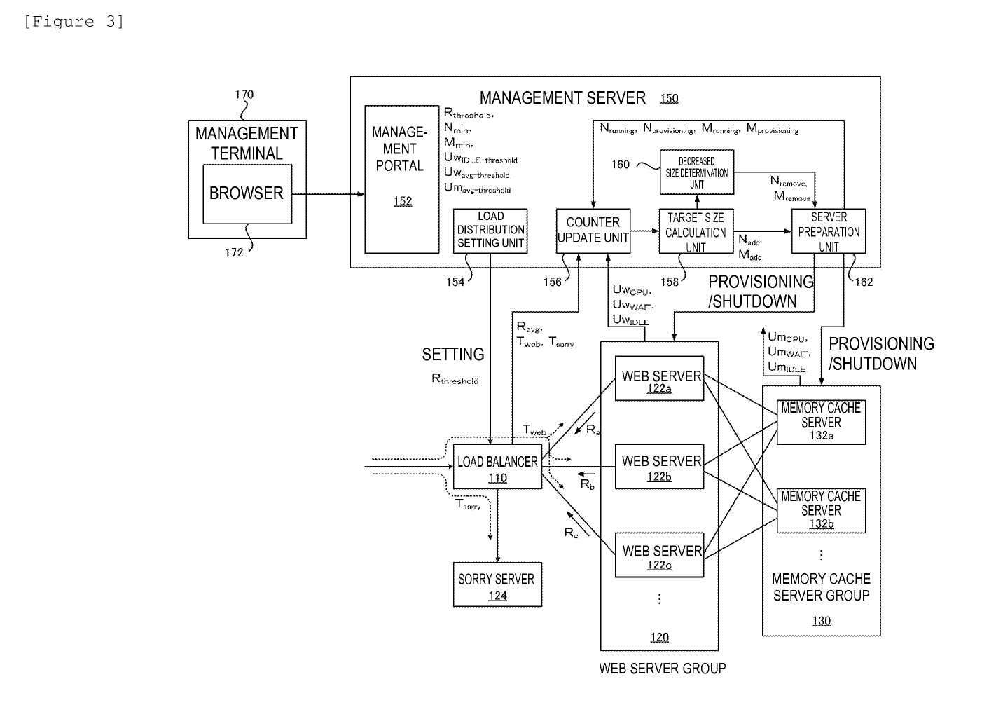

The virtual machines 50 are provisioned under instructions from the management server 150 in response to a virtual machine provisioning request from the cloud user, and are shut down under instructions from the management server 150 in response to a virtual machine shutdown request from the cloud user. Further, in embodiments of the present invention, an auto-scaling function for virtual machines in response to changes in demand is available: the virtual machines 50 are provisioned or shut down in response to satisfaction of a trigger condition of auto-scaling settings that conditions the increase or decrease of the virtual machines as defined by the cloud user. According to the auto-scaling function in an embodiment of the present invention, demands in the web system 104 are quantified, and a required target server size is determined on the basis of the quantified demands. Then, instances in the web server group 120 and the memory cache server group 130 are added or removed in a timely manner according to the difference between the target server size and the current size. Thus the server size can be automatically adjusted. Details of the auto-scaling mechanism for virtual machines in response to changes in demand according to embodiments of the present invention will be described below with reference to FIGS. 3 to 7.

FIG. 3 is a diagram showing functional blocks related to the auto-scaling mechanism for virtual machines in response to changes in demand, implemented in the provisioning system according to an embodiment of the present invention. FIG. 3 shows the management server 150 and the management terminal 170. Further, as components of the web system 104 to be addressed, FIG. 3 shows the load balancer 110, the web server group 120, the Sorry server 124, and the memory cache server group 130. In the described embodiment, the scaling target may be both of the web server group 120 and the memory cache server group 130, or only the web server group 120. For quantifying demands in the web system 104, the load balancer 110 provided in a stage preceding the web server group 120 (on the Internet side) is used. The web server group 120, which is the target of scaling and which is the target of load distribution by the load balancer for quantifying demands, constitutes a processing server group in this embodiment, and each instance (web server) 122 in the web server group 120 constitutes a processing server in this embodiment.

The management server 150 in this embodiment includes a management portal 152 providing an interface for service management. The cloud user can use a browser 172 on the management terminal 170 to access the management portal 152 according to the HTTP protocol and issue various management requests, including requests to make the auto-scaling settings, through a management menu. The auto-scaling settings made through the management portal 152 include (1) basic auto-scaling settings, (2) designation of a load balancer to be used in auto-scaling in response to changes in demand, (3) load distribution settings for the designated load balancer, (4) scale-up condition settings that condition the increase of the server size, and (5) scale-down condition settings that condition the decrease of the server size.

The basic auto-scaling settings include designation of server groups to be scaled (hereinafter referred to as scaling target server groups), and settings for each scaling target server group, such as an OS image and specs of each virtual machine, the initial number of machines, and the minimum and maximum numbers of machines. In the described embodiment, both of the web server group 120 and the memory cache server group 130 are, or only the web server group 120 is, designated as the scaling target server group(s). Also, the following description assumes that the web server group 120 and the memory cache server group 130 have their respective minimum numbers of machines Nₘᵢₙ and Mₘₒₙ designated, but their maximum numbers of machines not designated.

The auto-scaling mechanism for virtual machines in response to changes in demand according to embodiments of the present invention uses triggers, as well as a load balancer for quantifying demands. In the described embodiment, the load balancer 110 that distributes traffic from the Internet 102 among the web servers 122 in the web server group 120 is selected as (2) the designated load balancer.

In the auto-scaling mechanism according to embodiments of the present invention, the load distribution settings for the designated load balancer are incorporated in the setting items of the auto-scaling settings. Included in (3) the load distribution settings for the designated load balancer are (i) the load distribution scheme, (ii) designation of a load distribution target server group, (iii) designation of an alternate server, and (iv) a transfer condition for transferring to the alternate server.

For (i) the load distribution scheme, any scheme may be employed, including, but not limited to: a round-robin scheme that assigns requests in order; a weighted round-robin scheme that assigns requests at a given ratio; a minimum number of connections scheme that assigns requests to instances having fewer connections; a minimum number of clients scheme that assigns requests to instances having fewer connecting clients; a minimum amount of data communication scheme that assigns requests to instances having smaller amount of communication being processed; a minimum response time scheme that assigns requests to instances having shorter response times; and a minimum server load scheme that assigns requests to instances having lower CPU, memory, or I/O utilization rates.

In whichever scheme, from the viewpoint of appropriately maintaining ongoing sessions of existing users as will be described in detail below, what is called a session maintaining function is preferably enabled so that relevant requests among requests sent from clients are assigned to the same server. Any scheme may be employed as the session maintaining function, including: a scheme that identifies a client from a sender IP address of a request; a scheme that identifies a client from information registered in Cookie; a URL rewrite scheme that identifies a client from information embedded in a URL; a scheme that identifies a client from authentication information in an HTTP request header; and a scheme that identifies a client from an SSL session ID.

In the described embodiment, the web server group 120 is designated as (ii) the load distribution target server group, and the Sorry server 124 is designated as (iii) the alternate server. According to designation of the load distribution target server group and the alternate server group by the cloud user, communication settings are internally made, including settings of IP addresses and port numbers of the instances 122a to 122z in the load distribution target server group and the Sorry server 124.

Generally, examples of (iv) the transfer condition for transferring to the alternate server may include threshold conditions for various metrics of the instances in the load distribution target server group for the designated load balancer 110, such as the average CPU utilization rate, the average memory utilization rate, the average degree of I/O utilization, the average throughput, the average number of connections, the average number of clients, the average amount of data communication, and the average value of response performance. From the viewpoint of appropriately detecting the overload state of the web system 104, a threshold condition for an average value of responsivity, such as the average response time or the average response speed, of the instances is preferably used. The described embodiment uses a condition that the average response time of the instances in the web server group 120 is above a threshold R_{threshold}. Here, “average” is used to mean one or both of the time average and the instance average. The threshold R_{threshold} for the average response time may be, for example, a value specified in SLA (Service Level Agreement) in cloud services.

Included in (4) the scale-up condition settings are: a trigger condition in scaling up for increasing the server size (hereinafter, the trigger condition for scaling up is referred to as a scale-up trigger condition); and a scale unit for scaling up (hereinafter, the scale unit for scaling up is referred to as a scale-up scale unit). The scale-up scale unit may be simply designated as the number of instances, and may be selected as either a fixed value or a demand-dependent variable value. Selecting a demand-dependent variable value as the scale-up scale unit means selecting the auto-scaling in response to changes in demand according to embodiments of the present invention. If a demand-dependent variable value is selected and if a calculation scheme for determining the variable value is selectable from a number of candidates, the scale-up condition settings may include designation of the calculation scheme.

Generally, examples of the scale-up trigger condition may include threshold conditions for various metrics of the instances in the scaling target server group, such as the average CPU utilization rate, the average memory utilization rate, the average degree of I/O utilization, the average throughput, the average number of connections, the average number of clients, the average amount of data communication, and the average value of response performance. From the viewpoint of appropriately detecting the overload state of the entire web system 104 and triggering a scale-up, it is preferable to use a threshold condition for an average value of responsivity, such as the average response time or the average response speed, of the web server group 120 that is the load distribution target for the designated load balancer. Since transfer of traffic to the alternate server means an insufficient server size of the web system 104, the scale-up trigger condition may preferably be the same as the above-described transfer condition for the designated load balancer. In the described embodiment, the scale-up trigger condition for the web server group 120 is the same as the transfer condition for the designated load balancer, i.e., that the average response time of the web server group 120 is above the threshold R_{threshold}.

If more than one scaling target server group is designated, the scale-up trigger condition may be individually set for each scaling target server group. If a multi-layer architecture configuration as shown in FIG. 3 is employed and more than one layer is scaled, it is preferable to set a condition that allows identifying which layer is the bottleneck in the overload state.

Metrics that are easily observable by a cloud provider and are related to the CPU of each instance 122 in the web server group 120 may include: the CPU utilization rate indicating the percentage of time during which the CPU is actually used (which may hereinafter be referred to as a CPU %); the waiting rate indicating the percentage of waiting time for inputting to/outputting from a local disk (which may hereinafter be referred to as a WAIT %); and the idle rate indicating the percentage of idle time during which the CPU is not used (which may hereinafter be referred to as an IDLE %). If determination of an overload state of the web system 104 is based on whether or not the average response time of the web server group 120 is above the threshold R_{threshold} as described above, there may be a case that the average IDLE % of the instances of the web server group 120 is not below a predetermined value, although the average response time is above the threshold and an overload state is determined. In this case, it can be estimated that the bottleneck is not in the web server group 120 but in the following stage. This nature can be utilized to determine whether the bottleneck is in the web server group 120 or in the memory cache server group 130 at the following stage according to a condition using a threshold Uw_{IDLE-threshold} for the average IDLE % of the web server group 120. The described embodiment uses a scale-up trigger condition for the memory cache server group 130 such that the average response time of the web server group 120 is above the threshold R_{threshold} of the web server group 120 and the average IDLE % of the web server group 120 is above the threshold Uw_{IDLE-threshold}.

Included in (5) the scale-down condition settings are: a trigger condition in scaling down for decreasing the server size (hereinafter, the trigger condition for scaling down is referred to as a scale-down trigger condition); and a scale unit for scaling down (hereinafter, the scale unit for scaling down is referred to as a scale-down scale unit). The scale-down scale unit may be simply designated as the number of instances, and may be selected as either a fixed value or a demand-dependent variable value. Examples of the scale-down trigger condition may include threshold conditions for various metrics similar to those described above. In the described embodiment, a threshold Uw_{avg-threshold} for the average resource utilization rate of the web server group 120 is used as the scale-down trigger condition for the web server group 120, and a threshold Um_{avg-threshold} for the average resource utilization rate of the memory cache server group 130 is used as the scale-down trigger condition for the memory cache server group 130.

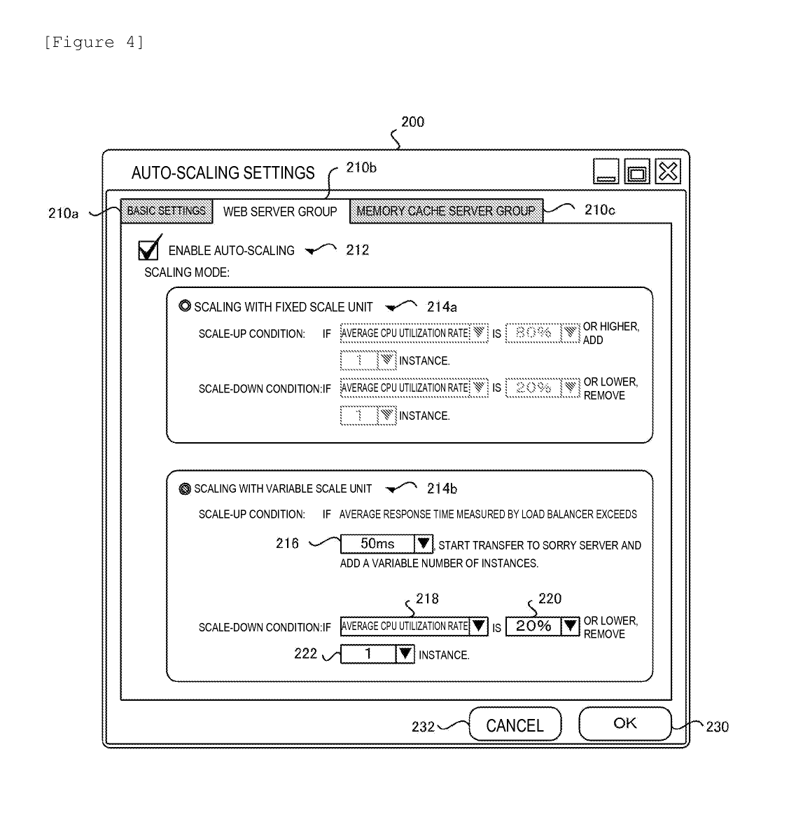

FIG. 4 illustrates a management screen for making the auto-scaling settings provided by the management portal in the provisioning system 100 according to an embodiment of the present invention. The management screen 200 shown in FIG. 4 includes a basic auto-scaling setting tab 210a, a web server group setting tab 210b, and a memory cache server group setting tab 210c. The web server group setting tab 210b is selected in the state shown in FIG. 4, so that graphical user interface (GUI) parts for designating settings related to the web server group 120 are disposed on the screen.

The example shown in FIG. 4 illustrates a checkbox 212 for enabling or disabling the auto-scaling function for the web server group 120, and radio buttons 214a and 214b for selecting a scaling mode for the web server group 120. As auto-scaling modes, scaling with a fixed scale unit 214a and scaling with a variable scale unit 214b are selectably displayed. In FIG. 4, scaling with a variable scale unit 214b is selected. The auto-scaling mechanism for virtual machines in response to changes in demand according to embodiments of the present invention corresponds to scaling with a variable scale unit.

Detailed settings for scaling with a variable scale unit 214b include scale-up condition settings and scale-down condition settings. The scale-up condition settings and the scale-down condition settings are made by selecting among choices in a pull-down menu 216 and in pull-down menus 218, 220, and 222, respectively. With respect to the scale-up condition settings, FIG. 4 illustrates a setting of the transfer condition and the scale-up trigger condition “the average response time of the web server group 120 measured by the load balancer is above 50 ms.” FIG. 4 also illustrates a setting of the scale-down trigger condition “the average CPU utilization rate of the web server group 120 is below 20% or lower” and a setting of the scale-down scale unit fixed to 1. FIG. 4 illustrates the management setting screen for the web server group 120, and detailed description is omitted for management setting screens for the memory cache server group 130 and for basic settings.

Referring again to FIG. 3, as functional units for implementing the auto-scaling mechanism, the management server 150 further includes a load distribution setting unit 154, a counter update unit 156, a target size calculation unit 158, a decreased size determination unit 160, and a server preparation unit 162. The load distribution setting unit 154, in response to a management request for the auto-scaling settings issued from the cloud user through the management portal 152, causes the above-described load distribution settings for the designated load balancer to be enforced on the load balancer 110. Specifically, settings enforced on the load balancer 110 include: a setting of the load distribution scheme; communication settings such as IP addresses of virtual machines as the load distribution target and of the alternate server; and a setting of the transfer condition.

The load balancer 110, according to the settings enforced by the load distribution setting unit 154, assigns requests issued via the Internet 102 among the instances 122 in the web server group 120 and monitors satisfaction of the transfer condition. If an overload state of the web system 104 is detected, the load balancer 110 transfers requests to the Sorry server 124. The Sorry server 124 is a web server that, when the web server group 120 is overloaded, responds to the transferred requests on behalf of the web server group 120 by returning a busy message to users. The Sorry server 124 is also a server that can be regarded as having a substantially infinite processing capability with respect to the processing of responding on behalf of the target server. Although the described embodiment employs one Sorry server as the alternate, there may be multiple Sorry servers.

For confirming correct operation of the web servers 122 that are the load distribution target and for monitoring satisfaction of the transfer condition, the load balancer 110 in this embodiment regularly transmits a keep-alive packet to each web server 122 to monitor response times Ra to Rc of the web servers 122. If an event that any of the response times is above a given time is continuously observed for a given number of times, the load balancer 110 determines a down state of a web server 122 in question and excludes the web server 122 from the load distribution target. The load balancer 110 also calculates the time average and the instance average of the observed response times. If the average response time is above the threshold R_{threshold} to satisfy the transfer condition, the load balancer 110 transfers requests to the Sorry server 124.

Requests transmitted by the load balancer 110 to the Sorry server 124 may preferably include only requests from new users and exclude requests from existing users who have already established sessions. This allows processing excessive requests without affecting the ongoing sessions of the existing users. For quantifying demands in the web system 104, the load balancer 110 in this embodiment measures the amount of traffic transferred to the web server group 120 per unit time and the amount of traffic transferred to the Sorry server 124 per unit time, and stores the measurements. These amounts of transferred traffic may be quantified in terms of the number of connections, the amount of data communication, etc., transferred to the web servers 122 or the Sorry server 124. From the viewpoint of accurate quantification of demands in the web system 104, it is preferable to use a quantity such as the number of connections, the number of clients, or the number of sessions. Using the number of connections, the number of clients, or the number of sessions allows more accurate quantification of demands in the web system 104. This is because responses to requests transferred to the Sorry server 124 essentially involve only a small amount of data, i.e., busy messages, whereas responses by the web servers 122 may involve a large amount of data traffic.

The counter update unit 156 regularly or irregularly collects information to update monitoring counter values required for the auto-scaling in response to changes in demand according to the embodiment of the present invention. The required monitoring counter values include values of metrics obtained from the load balancer 110, such as the average response time R_{avg} experienced by the load balancer 110, the amount of traffic T_{web} transferred to the web server group 120 per unit time, and the amount of traffic T_{sorry} transferred to the Sorry server 124 per unit time. The required monitoring counter values further include metrics obtained from the instances in the scale target server groups, such as the average CPU % Uw_{CPU} the average WAIT % Uw_{WAIT} and the IDLE % Uw_{IDLE} of the instances 122 in the web server group 120, and the CPU % Um_{CPU}, the WAIT % Um and the IDLE % Um_{IDLE} of the instances 132 in the memory cache server group 130. Time averages or instance averages of these metrics obtained from the instances are calculated and held in counters. The average CPU % Uw_{CPU} and the average WAIT % Uw_{WAIT} of the instances 122 in the web server group 120 are used as evaluation indices for evaluating the local load on the web servers 122, and the IDLE % Uw_{IDLE} is used as an evaluation index for determining the bottleneck as described above. The required monitoring counter values further include state variables obtained from the server preparation unit 162 managing virtual machine provisioning, such as the number of running instances N_{running} and the number of instances in preparation for provisioning N_{provisioning} in the web server group 120, and the number of running instances M_{running} and the number of instances in preparation for provisioning M_{provisioning} in the memory cache server group 130. The counter update unit 156 constitutes a transfer amount acquisition unit in this embodiment.

The target size calculation unit 158 refers to the monitoring counter values that are updated and monitors satisfaction of the scale-up trigger condition. If the scale-up trigger condition is satisfied, the target size calculation unit 158 calculates the target server size of each processing server group with reference to the amount of traffic transferred by the designated load balancer to the processing server group per unit time, and the amount of traffic transferred by the load balancer to the alternate server per unit time. In the example shown in FIG. 3, the target size calculation unit 158 quantifies demands in the web system 104 from the amount of traffic T_{web} transferred to the web server group 120 and the amount of traffic T_{sorry} transferred to the Sorry server 124. The target size calculation unit 158 then calculates the target server size of each of the web server group 120 and the memory cache server group 130 depending on demands. The target server size represents the server size to achieve, and it can be simply quantified in terms of the number of servers (the number of instances) if the instances in each server group are substantially the same in specs. If the instances in each processing server group are different in specs, appropriate corrections may be made depending on the specs of each instance. In this embodiment, for convenience of description, the target server size is quantified in terms of the number of servers. The following equations (1) to (3) illustrate arithmetic expressions for determining the target server sizes. A function Ceil ( ) in the following equations (1) to (3) represents a ceiling function.

$$[ Formula 1 ]$$

$$\begin{matrix}{N}_{target} = ceil ( {N}_{running} \times ( \frac{{T}_{web} + {T}_{sorry}}{{T}_{web}} ) ) & ( 1 ) \\ {N}_{target} = ceil ( ( {Uw}_{CPU} + {Uw}_{WAIT} ) \times {N}_{running} \times ( \frac{{T}_{web} + {T}_{sorry}}{{T}_{web}} ) ) & ( 2 ) \\ {M}_{target} = ceil ( {M}_{running} \times ( \frac{{T}_{web} + {T}_{sorry}}{{T}_{web}} ) ) & ( 3 )\end{matrix}$$

The equations (1) and (2) represent arithmetic expressions that can each be used when only the web server group 120 is the scaling target. The equations (2) and (3) represent arithmetic expressions used for the web server group 120 and the memory cache server group 130, respectively, when the web server group 120 and the memory cache server group 130 are both the scaling targets. The equations (1) and (2) represent arithmetic expressions for calculating the target server size N_{target} of the web server group 120, and the equation (3) represents an arithmetic expression for calculating the target server size M_{target} of the memory cache server group 130. In the equation (2), (Uw_{CPU}+Uw_{WAIT}) is introduced for reflecting the evaluation of the local load on the web servers 122.

The target size calculation unit 158 further calculates the scale-up scale unit from the difference between the target server size and the current server size and requests the server preparation unit 162 to provision instances in each processing server groups. The current server size and the scale-up scale unit may similarly be quantified simply in terms of the number of servers if the instances in each processing server group are substantially the same in specs. In this embodiment, for convenience of description, the current server size and the scale unit are quantified in terms of the numbers of servers. The current server size is determined as the sum of the number of running instances and the number of instances that are in preparation to be provisioned, at the time of observation. The scale-up scale unit is determined as the difference between the target server size and the current server size. In the described embodiment, the target size calculation unit 158 can calculate the number of instances to be added N_{add} for the web server group 120 from the difference between the target server size N_{target} and the current server size (N_{running}+N_{provisioning}) of the web server group 120. As necessary, the target size calculation unit 158 can calculate the number of instances to be added M_{add} for the memory cache server group 130 from the difference between the target server size M_{target} and the current server size (M_{running}+M_{provisioning}) of the memory cache server group 130.

The described embodiment assumes that the number of instances to be added N_{add} for the web server group 120 is calculated from the difference between the target server size N_{target} and the current server size (N_{running}+N_{provisioning}) of the web server group 120, and N_{add} is employed in any case as the number of instances to be added. In other embodiments, however, this may be combined with demand prediction using history. For example, in addition to the target server size based on the demands quantified by the load balancer, a predicted server size based on demand prediction using history information is determined. If the demands quantified by the load balancer are underestimated compared with the demands predicted with the history information, the server size based on the demand prediction may be selected. This allows addressing unpredicted changes in demand while making correction based on the demand prediction.

The decreased size determination unit 160 refers to the monitoring counter values that are updated and monitors satisfaction of the scale-down trigger condition. If the scale-down trigger condition is satisfied, the decreased size determination unit 160 determines the decreased server size of each processing server groups. If the scale-down scale unit is fixed, the decreased size determination unit 160 may determine the decreased server size as the fixed value. If the scale-down scale unit is variable, the decreased size determination unit 160 may calculate an appropriate server scale from the resource utilization rate and determine a required scale unit from the difference between the current server scale and the calculated server scale. Since redundant resources usually exist in the case of scaling down, the appropriate server scale in the case of scaling down can be easily calculated from the resource utilization rate such as the CPU utilization rate without the need to use the above-described amounts of transferred traffic. In the embodiment shown in FIG. 3, the decreased size determination unit 160 may determine the number of instances to be removed Nᵣₑₘₒᵥₑ for the web server group 120, and as necessary, the number of instances to be removed Mᵣₑₘₒᵥₑ for the memory cache server group 130.

In scaling up, the server preparation unit 162 performs a process of provisioning instances in each processing server group in order to increase the current server size of the processing server group to the target server size. Further, in scaling down, the server preparation unit 162 performs a process of shutting down instances in each processing server group according to the scale-down scale unit determined by the decreased size determination unit 160. In the embodiment shown in FIG. 3, in scaling up, the server preparation unit 162 provisions the number of instances to be added N_{add} calculated by the target size calculation unit 158, for the web server group 120, and as appropriate, provisions the number of instances to be added M_{add}, for the memory cache server group 130. The server preparation unit 162 manages the numbers of running instances N_{running} and M_{running} and the numbers of instances in preparation for provisioning N_{provisioning} and M_{provisioning}, and notifies the counter update unit 156 of these numbers of instances. In scaling down, the server preparation unit 162 may shut down the numbers of instances to be removed Nᵣₑₘₒᵥₑ and Mᵣₑₘₒᵥₑ for the web server group 120 and the memory cache server group 130, as determined by the decreased size determination unit 160.

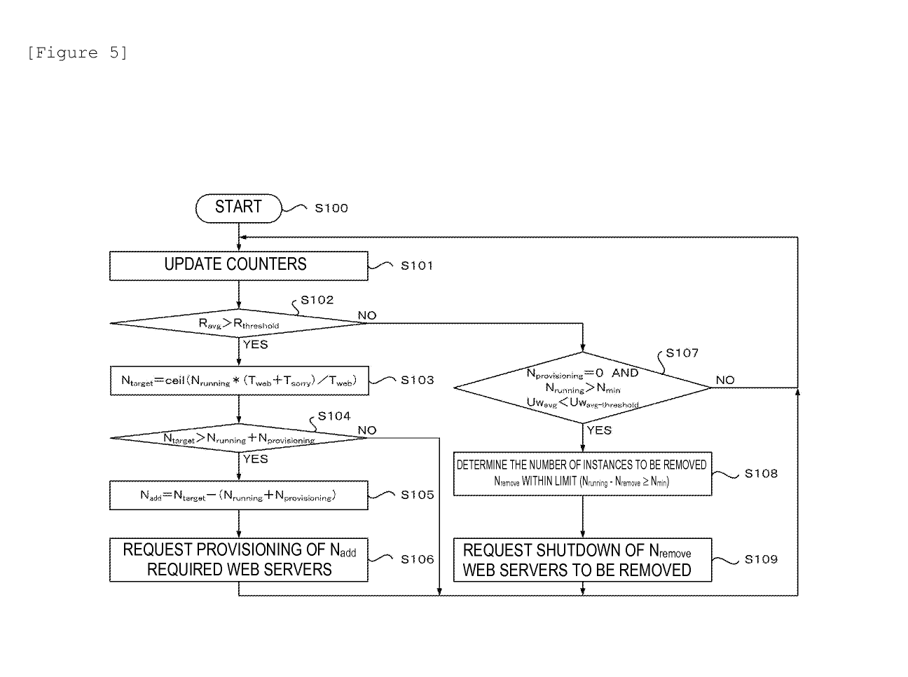

FIG. 5 is a flowchart showing an auto-scaling process in response to changes in demand, implemented in the provisioning system according to an embodiment of the present invention. FIG. 5 shows an auto-scaling process in a case that only the web server group 120 is the scaling target server group and the above equation (1) is used to calculate the target server size. The following description assumes that, at the start of the process shown in FIG. 5, predetermined numbers of instances in the web server group 120, the memory cache server group 130, and the database server group 140 are already deployed, and the auto-scaling settings are already made, including: the threshold R_{threshold} for the average response time as the transfer condition and the scale-up trigger condition; the minimum number of machines Nₘₒₙ in the web server group 120; and the threshold Uw_{avg-threshold} for the average resource utilization rate of the web server group 120 as the scale-down condition.

The process shown in FIG. 5 is started in step S100, for example in response to enabling the auto-scaling function of the web system 104. In step S101, the counter update unit 156 collects information from the load balancer 110, the web servers 122, and the server preparation unit 162, and updates the monitoring counter values. The monitoring counter values used in the process shown in FIG. 5 include the average response time R_{avg}, the amount of traffic T_{web} transferred to the web server group 120 per unit time, the amount of traffic T_{sorry} transferred to the Sorry server 124 per unit time, the average resource utilization rate Uw_{avg} of the web server group 120, the number of running instances N_{running} in the web server group 120, and the number of instances in preparation for provisioning N_{provisioning} in the web server group 120.

In step S102, the target size calculation unit 158 refers to the monitoring counter values to determine whether or not the average response time R_{avg} is above the threshold R_{threshold}. If it is determined that the average response time R_{avg} is above the threshold R_{threshold} (YES) in step S102, the process proceeds to step S103. In step S103, the target size calculation unit 158 refers to the monitoring counter values to calculate the target server size N_{target} of the web server group 120 according to the equation (1). In step S104, the target size calculation unit 158 compares the target server size N_{target} with the sum of the number of running instances and the number of instances in preparation for provisioning (N_{running}+N_{provisioning}) to determine whether or not the target server size N_{target} is larger. If it is determined that the target server size N_{target} is larger (YES) in step S104, the process proceeds to step S105. In step S105, the target size calculation unit 158 calculates the difference between the target server size and the current size (N_{target}−(N_{running}+N_{provisioning})) as the number of instances to be added N_{add}, and asks the server preparation unit 162 for provisioning.

In step S106, the server preparation unit 162 selects appropriate physical host machines 10 and requests provisioning by the control module 46 on each physical host machine 10 to prepare N_{add} instances in total for the web server group 120. After the lapse of a given interval, the process loops to step S101 to repeat updating the counters and monitoring satisfaction of the scale-up trigger condition. If it is determined that the target server size N_{target} is not larger (NO) in step S104, the process directly loops to step S101 after the lapse of an appropriate interval to repeat updating the counters and monitoring satisfaction of the scale-up trigger condition.

If it is determined that the average response time R_{avg} is not above the threshold R_{threshold} (NO) in step S102, the process branches to step S107. In this case, the scale-up trigger condition is not satisfied, so that satisfaction of the scale-down trigger condition is then monitored. In step S107, the decreased size determination unit 160 determines whether or not instances in preparation for provisioning do not exist in the web server group 120 (N_{provisioning}=0), the number of running instances in the web server group 120 is above the minimum number of machines Nₘᵢₙ (N_{running}>Nₘᵢₙ), and the average resource utilization rate Uw_{avg} of the web server group 120 is below the threshold UW_{avg-threshold}. Here, the average resource utilization rate Uw_{avg}, indicating the local load on the web server group 120, may be the average CPU utilization rate CPU % or the sum of the average CPU utilization rate CPU % and the waiting rate WAIT % of the web server group 120, for example.

If it is determined that all the conditions are satisfied (YES) in step S107, the process proceeds to step S108. In step S108, the decreased size determination unit 160 determines the number of instances to be removed Nᵣₑₘₒᵥₑ within a limit such that removing Nᵣₑₘₒᵥₑ instances from the currently running N_{running} instances does not result in falling below the minimum number of machines Nₘᵢₙ, and asks the server preparation unit 162 for shutdown. For example, if a fixed number of instances to be removed is set as the scale-down condition, the fixed number (one or greater) that satisfies the above limit is determined as the number of instances to be removed Nᵣₑₘₒᵥₑ. If a variable number of instances to be removed is set as the scale-down condition, a variable number is calculated and then the variable number (one or greater) that satisfies the above limit is determined as the number of instances to be removed Nᵣₑₘₒᵥₑ. As described above, the value of the variable number may be determined from the average resource utilization rate Uw_{avg} of the web server group 120.

In step S109, the server preparation unit 162 selects Nᵣₑₘₒᵥₑ instances from all the instances in the web server group 120 and requests shutdown by the control module 46 on each physical host machine 10 on which the selected instances are running. Thus the server preparation unit 162 removes Nᵣₑₘₒᵥₑ instances in total in the web server group 120. After the lapse of an appropriate interval, the process loops to step S101 to repeat updating the counters and monitoring satisfaction of the trigger condition. If it is determined that not all the conditions are satisfied (NO) in step S107, the process directly loops to step S101 after the lapse of an appropriate interval to repeat updating the counters and monitoring satisfaction of the trigger condition.

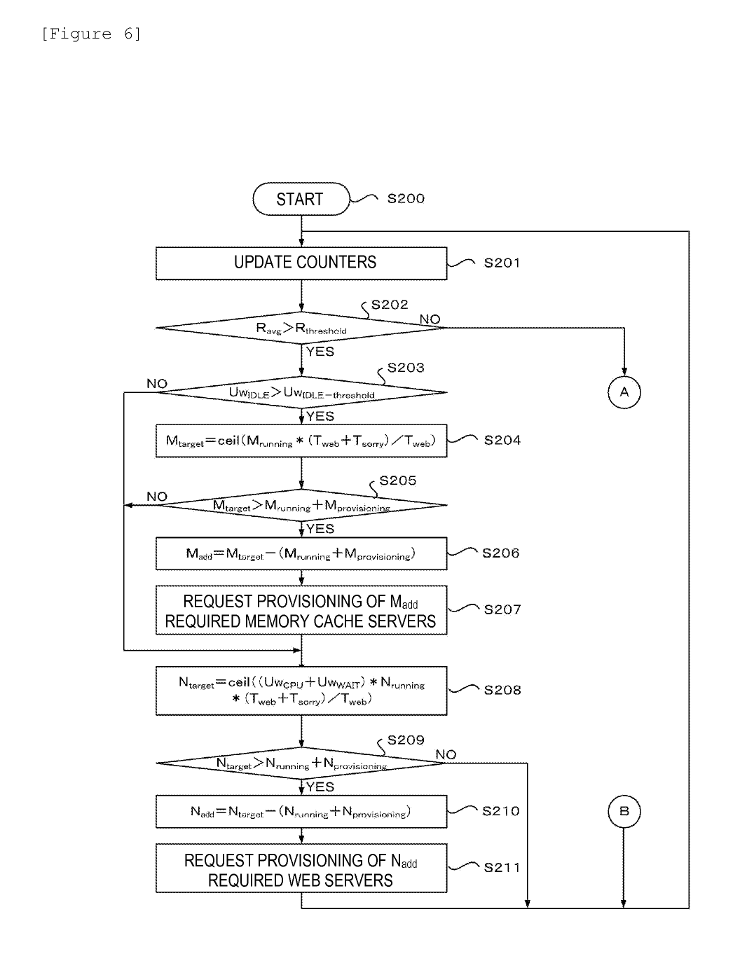

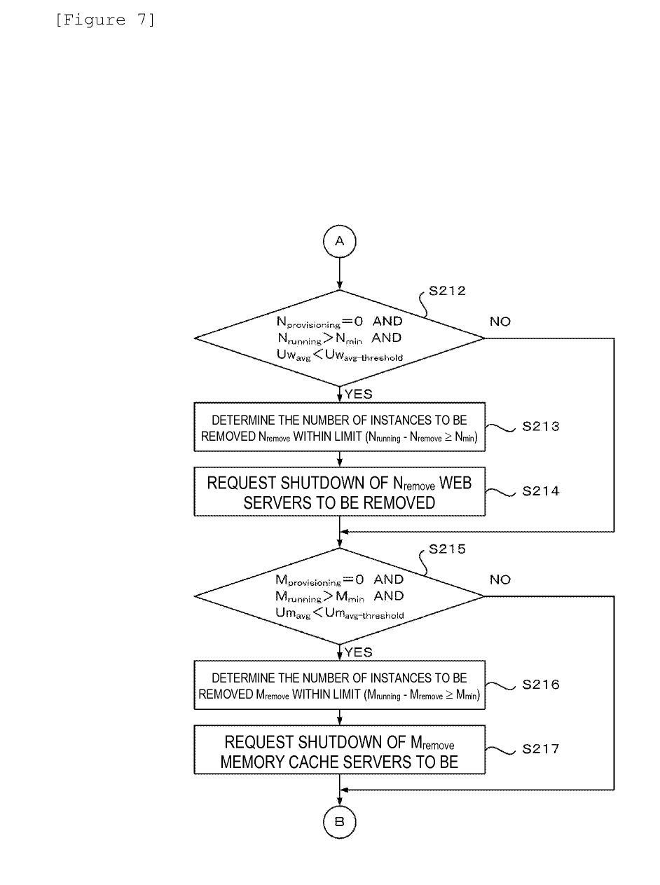

FIGS. 6 and 7 are a flowchart showing another auto-scaling process in response to changes in demand, implemented in the provisioning system according to an embodiment of the present invention. FIGS. 6 and 7 shows an auto-scaling process in a case that both of the web server group 120 and the memory cache server group 130 are the scaling target server groups and the above equations (2) and (3) are used to calculate the respective target server sizes. As in FIG. 5, the following description assumes that, at the start of the process shown in FIGS. 6 and 7, predetermined numbers of instances in the web server group 120, the memory cache server group 130, and the database server group 140 are already deployed, and the auto-scaling settings are already made, including: the threshold R_{threshold} for the average response time as the transfer condition and the scale-up trigger condition; the threshold Uw_{IDLE-threshold} for the average IDLE % of the web server group 120 as the scale-up trigger condition for the memory cache server group 130; the minimum number of machines Nₘᵢₙ in the web server group 120; the minimum number of machines Mₘᵢₙ in the memory cache server group 130; the threshold Uw_{avg-threshold} for the average resource utilization rate of the web server group 120 as the scale-down condition; and the threshold Um_{avg-threshold} for the average resource utilization rate Um_{avg} of the memory cache server group 130.

The process shown in FIGS. 6 and 7 is started in step S200, for example in response to enabling the auto-scaling function of the web system 104. In step S201, the counter update unit 156 collects information from the load balancer 110, the web servers 122, the memory cache servers 132, and the server preparation unit 162, and updates the monitoring counter values. The monitoring counter values used in the process shown in FIGS. 6 and 7 include those described with reference to FIG. 5: the average response time R_{avg}, the amount of traffic T_{web} transferred to the web server group 120, the amount of traffic T_{sorry} transferred to the Sorry server 124, the average resource utilization rate Uw_{avg}, the number of running instances N_{running}, and the number of instances in preparation for provisioning N_{provisioning}. In addition, the monitoring counter values include the average resource utilization rate Um_{avg} of the memory cache server group 130, the number of running instances M_{running} in the memory cache server group 130, and the number of instances in preparation for provisioning N_{provisioning} in the memory cache server group 130.

In step S202, the target size calculation unit 158 refers to the monitoring counter values to determine whether or not the average response time R_{avg} is above the threshold R_{threshold}. If it is determined that the average response time R_{avg} is above the threshold R_{threshold} (YES) in step S202, the process proceeds to step S203. In step S203, the target size calculation unit 158 refers to the monitoring counter values to determine whether or not the average IDLE % Uw_{IDLE} of the web server group 120, which is part of the scale-up trigger condition for the memory cache server group 130, is above the threshold Uw_{IDLE-threshold}. If it is determined that the average IDLE % Uw_{IDLE} is above the threshold Uw_{IDLE-threshold} (YES) in S203, the process proceeds to step S204.

In step S204, the target size calculation unit 158 refers to the monitoring counter values to calculate the target server size M_{target} of the memory cache server group 130 according to the above equation (3). In step S205, the target size calculation unit 158 determines whether or not the target server size M_{target} of the memory cache server group 130 is larger than the sum of the number of running instances and the number of instances in preparation for provisioning (M_{running}+M_{provisioning}). If it is determined that the target server size M_{target} is larger (YES) in step S205, the process proceeds to step S206. In step S206, the target size calculation unit 158 calculates the difference between the target server size and the current size (M_{target}−(M_{running}−M_{provisioning})) as the number of memory cache servers 132 to be added M_{add}, and asks the server preparation unit 162 for provisioning. In step S207, the server preparation unit 162 selects appropriate physical host machines 10 and requests provisioning to prepare M_{add} instances in total for the memory cache server group 130. The process then proceeds to step S208.

If it is determined that the average IDLE % Uw_{IDLE} is not above the threshold Uw_{IDLE-threshold} (NO) in step S203, or if it is determined that the target server size M_{target} is not larger (NO) in step S205, the process directly proceeds to step S208. In step S208, the target size calculation unit 158 refers to the monitoring counter values to calculate the target server size N_{target} of the web server group 120 according to the above equation (2). In step S209, the target size calculation unit 158 determines whether or not the target server size N_{target} of the web server group 120 is larger than the sum of the number of running instances and the number of instances in preparation for provisioning (N_{running} N_{provisioning}).

If it is determined that the target server size N_{target} is larger (YES) in step S209, the process proceeds to step S210. In step S210, the target size calculation unit 158 calculates the difference between the target server size and the current size (N_{target}−(N_{running}+N_{provisioning})) as the number of web servers 122 to be added N_{add}, and asks the server preparation unit 162 for provisioning. In step S211, the server preparation unit 162 selects appropriate physical host machines 10 and requests provisioning to prepare N_{add} instances in total for the web server group 120. After the lapse of a given interval, the process loops to step S201 to repeat updating the counters and monitoring satisfaction of the scale-up trigger condition. If it is determined that the target server size N_{target} is not larger (NO) in step S209, the process directly loops to step S201 after the lapse of a given interval.

If it is determined that the average response time R_{avg} is not above the threshold R_{threshold} (NO) in step S202, the process branches to step S212 shown in FIG. 7 via a point A. In this case, the scale-up trigger condition is not satisfied, so that satisfaction of the scale-down trigger condition is then monitored. In step S212, the decreased size determination unit 160 determines whether or not instances in preparation for provisioning do not exist in the web server group 120 (N_{provisioning}=0), the number of running instances in the web server group 120 is above the minimum number of machines Nₘᵢₙ (N_{running}>Nₘᵢₙ), and the average resource utilization rate Uw_{avg} of the web servers 122 is below the threshold Uw_{avg-threshold}. If it is determined that all the conditions are satisfied (YES) in step S212, the process proceeds to step S213. In step S213, the decreased size determination unit 160 determines the number of instances to be removed Nᵣₑₘₒᵥₑ within a limit such that removing Nᵣₑₘₒᵥₑ instances from the currently running N_{running} instances does not result in falling below the minimum number of machines Nₘᵢₙ, and asks the server preparation unit 162 for shutdown. In step S214, the server preparation unit 162 requests shutdown by physical host machines 10 running the instances in the web server group 120 to remove Nᵣₑₘₒᵥₑ instances in total. The process then proceeds to step S215. If it is determined that not all the conditions are satisfied (NO) in step S212, the process directly proceeds to step S215.

In step S215, the decreased size determination unit 160 determines whether or not instances in preparation for provisioning do not exist in the memory cache server group 130 (M_{provisioning}=0), the number of running instances in the memory cache server group 130 is above the minimum number of machines (M_{running}>Mₘᵢₙ), and the average resource utilization rate Um_{avg} of the memory cache servers 132 is below the threshold Um_{avg-threshold}. If it is determined that all the conditions are satisfied (YES) in step S215, the process proceeds to step S216. In step S216, the decreased size determination unit 160 determines the number of instances to be removed Mᵣₑₘₒᵥₑ within a limit such that removing Mᵣₑₘₒᵥₑ instances from the currently running M_{running} instances does not result in falling below the minimum number of machines Mₘᵢₙ, and asks the server preparation unit 162 for shutdown. In step S217, the server preparation unit 162 requests shutdown by physical host machines 10 running the instances in the memory cache server group 130 to remove Mᵣₑₘₒᵥₑ instances in total. After the lapse of an appropriate interval, the process loops to step S201 shown in FIG. 6 via a point B to repeat updating the counters and monitoring satisfaction of the trigger condition. If it is determined that not all the conditions are satisfied (NO) in step S215, the process directly loops to step S201 shown in FIG. 6 via the point B after the lapse of an appropriate interval to repeat updating the counters and monitoring satisfaction of the trigger condition.

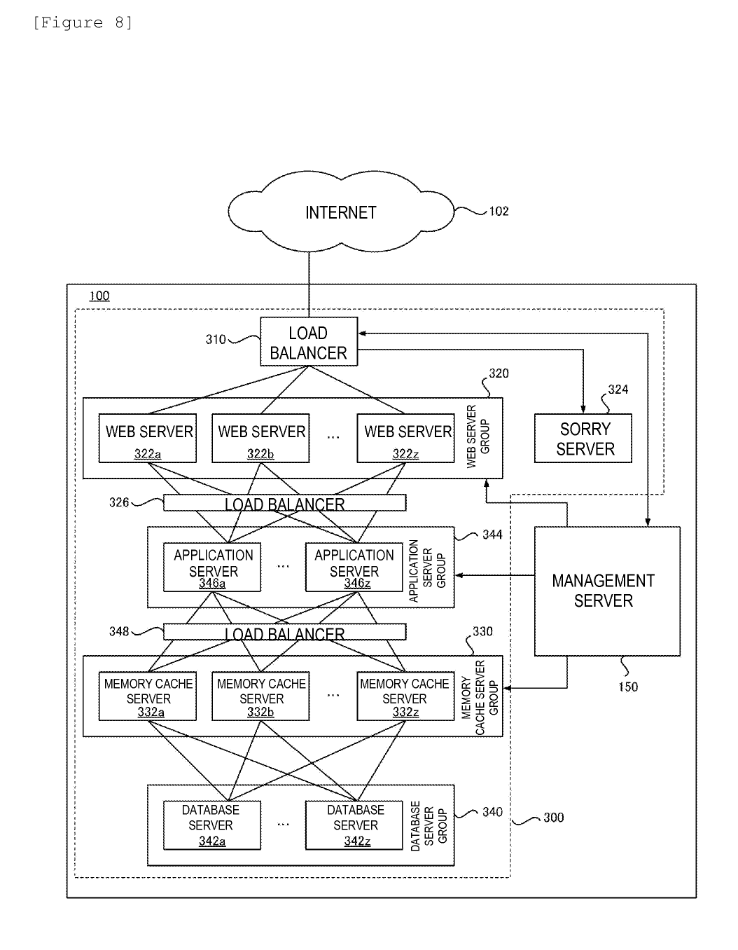

FIG. 8 is a diagram for describing the case of scaling a web system that employs another multi-layer architecture configuration in the provisioning system according to an embodiment of the present invention. In auto-scaling in response to changes in demand in a web system 300 shown in FIG. 8, an application server group 344 may be further added as a scaling target server group. In this case, the target server size of the application server group 344 may be determined in relation to the target server size of a web server group 320, or may be determined independently using arithmetic expressions similar to the above-described arithmetic expressions (1) to (3).

According to the above-described auto-scaling mechanism in embodiments of the present invention, in the case of scaling up, the amount of traffic transmitted by the load balancer to the processing server group and the amount of traffic transmitted by the load balancer to the alternate server are used to quantify demands in the web system. Then, instances in each processing server group are prepared in order to make up for the difference between a target server size determined from the quantified demands and the current server size.

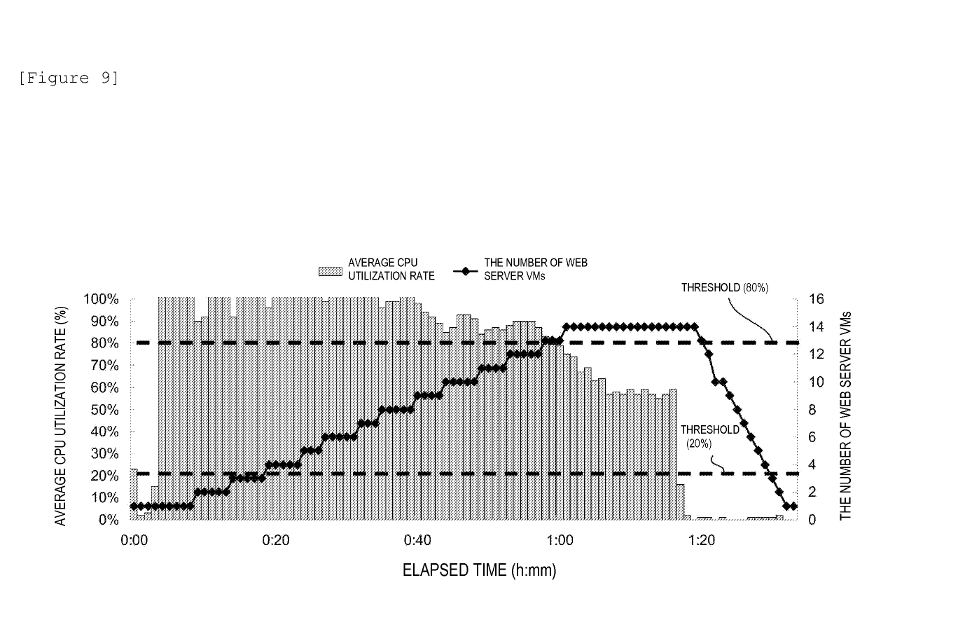

In the case of scaling up, it is generally difficult to quantify potential demands in the system. FIG. 9 is a graph showing changes over time in the number of web server instances according to auto-scaling in a conventional technique. The auto-scaling in the conventional technique shown in FIG. 9 is based on a definition such that one new instance is added if the average CPU utilization rate is 80% or higher, and one instance is removed if the average CPU utilization rate is 20% or lower. In FIG. 9, a bar graph (a left-side axis) indicates changes over time in average CPU utilization rate of web servers, and a line graph (a right-side axis) indicates the number of web server instances. It can be seen from FIG. 9 that the average CPU utilization rate becomes almost saturated in response to a sudden increase in web traffic, whereas web server instances are added one by one until activation of ultimate 14 instances over more than one hour.

Since the conventional technique shown in FIG. 9 uses a fixed number of instances as the scale unit, demands above a load capacity of the fixed number of instances cannot be promptly addressed. This may cause a delay corresponding to the time it takes to activate the instances, failing in keeping up with changes in demand. Also, since the instances are added by the fixed number, unnecessary instances may be prepared. Even if a variable scale unit depending on the load is employed, it is generally difficult to estimate the number of added instances that meets the demands. The reason is that the throughput of overloaded servers no more increases, and metrics such as the average CPU utilization rate and the network flow rate are saturated. For example, in the illustration in FIG. 9, the 14 instances could be activated at once if a total CPU utilization rate of 1400% for the ultimately required 14 instances could be measured in the beginning. However, as the bar graph shows, the average CPU utilization rate is saturated at 100%, so that the demands cannot be accurately estimated by using the average CPU utilization rate as a metric. This also applies to using other metrics obtained from each instance, such as the network flow rate and the memory utilization rate.

In contrast, the auto-scaling mechanism in embodiments of the present invention uses the load balancer and the alternate server to quantify demands in the web system on the basis of the amount of traffic transferred by the load balancer to the processing server group and the amount of traffic transferred by the load balancer to the alternate server. Therefore, demands can be accurately quantified even on the occurrence of a change in demand that causes metrics such as the CPU utilization rate and the network flow rate to be saturated. This leads to promptly addressing unexpected changes in demand. Further, the alternate server can be regarded to have a substantially infinite processing capability with respect to the processing of responding on behalf of the target server, so that the throughput of the alternate server is hardly saturated. Therefore, demands can be accurately quantified even on the occurrence of a sudden change in demand that significantly exceeds the capacity of the current server size.

In embodiments of the present invention, the target server size can be determined using only metrics obtained from the load balancer and the virtual machines. This can realize accurate reactive auto-scaling even in a cloud environment, in which it is generally difficult for a cloud provider to obtain internal information on virtual machines because configuration of the virtual machines is left to the cloud user.

According to the above-described auto-scaling mechanism, an end user can have a benefit of a reduced waiting time when traffic suddenly increases. If only new requests are transferred to the alternate server, the end user can further have a benefit of no timeout of an existing session even in congested traffic. From the viewpoint of a cloud user, the cloud user can have a benefit of a reduction of chance loss caused by servers being down, a reduction in operational cost due to removal of unnecessary servers, and a reduction in manpower cost spent for detailed demand prediction and monitoring.

As described above, embodiments of the present invention can provide an information processing system, an information processing apparatus, a method of scaling, a program, and a recording medium that implement an auto-scaling mechanism capable of increasing the server size in response to even a sudden unexpected change in demand.

The provisioning system according to embodiments of the present invention is provided by loading a computer-executable program into a computer system and implementing each functional unit. Such a program may be implemented as a computer-executable program, for example written in a legacy programming language such as FORTRAN, COBOL, PL/I, C, C++, Java®, JavaBeans®, Java® Applet, JavaScript, Perl, or Ruby, or in an object-oriented programming language, and may be stored and distributed in a machine-readable recording medium.

While the present invention has been described with embodiments and examples shown in the drawings, the present invention is not limited to the embodiments shown. Rather, modifications may be made to the present invention to the extent conceivable by those skilled in the art, including other embodiments, additions, alterations, and deletions. Such modifications are also within the scope of the present invention in any aspect as long as operations and advantages of the present invention are realized.

1) An information processing system comprising:
a processing server group comprising a plurality of processing servers;
an alternate server for responding to a request on behalf of the processing server group;
a load balancer distributing traffic among the processing servers in the processing server group and transferring traffic to the alternate server on condition that the processing server group becomes overloaded;
a target size calculating unit calculating a target size of the processing server group on the basis of the amount of traffic transferred by the load balancer to the processing server group and the amount of traffic transferred by the load balancer to the alternate server; and
a server preparation unit preparing the processing servers in the processing server group in order to increase the size of the processing server group to the target size.

2) The information processing system according to claim 1, wherein the target size calculating unit calculates the target size of the processing server group depending on an evaluation index representing a local load observed for the processing servers in the processing server group.

3) The information processing system according to claim 2, further comprising a second server group provided in a stage following the processing server group,
wherein the target size calculating unit determines a bottleneck from the evaluation index observed for the processing servers in the processing server group and, on condition that it is determined that the bottleneck is in the stage following the processing server group, calculates a target size of the second server group on the basis of the amount of traffic transferred to the processing server group and the amount of traffic transferred to the alternate server, and
the server preparation unit prepares processing servers in the second server group in order to increase the size of the second server group to the target size.

4) The information processing system according to claim 1, wherein the load balancer monitors response performance of the processing server group and determines that the processing server group is overloaded on condition that the response performance satisfies a transfer condition.

5) The information processing system according to claim 1, wherein the amounts of transferred traffic are quantified in terms of the number of connections, the number of clients, or the number of sessions.

6) The information processing system according to claim 1, wherein the alternate server is a Sorry server.

7) The information processing system according to claim 1, wherein the target size calculating unit calculates the target size of the processing server group depending on the ratio between the amount of traffic transferred to the processing server group and the amount of traffic transferred to the alternate server.

8) The information processing system according to claim 2, wherein the processing servers each run on a virtual machine, the evaluation index representing the local load is a resource utilization rate of virtual machines on which the processing servers run, the server preparation unit prepares the processing servers by instructing a hypervisor on a physical machine to activate instances of the virtual machines that run the processing servers in the processing server group, and the target size of the processing server group is quantified in terms of the number of instances of the virtual machines that run the processing servers in the processing server group.

9) The information processing system according to claim 3, wherein the processing server group comprises web servers as processing servers, and the second server group comprises application servers or memory cache servers as processing servers.

10) An information processing apparatus comprising:
a transfer amount acquisition unit acquiring, from a load balancer, the amount of traffic transferred to a processing server group and the amount of traffic transferred to an alternate server, the load balancer distributing traffic among a plurality of processing servers in the processing server group and transferring traffic to the alternate server on condition that the processing server group becomes overloaded;
a target size calculating unit calculating a target size of the processing server group on the basis of the amount of traffic transferred to the processing server group and the amount of traffic transferred to the alternate server; and
a server preparation unit preparing the processing servers in the processing server group in order to increase the size of the processing server group to the target size.

11) The information processing apparatus according to claim 10, wherein the target size calculating unit calculates the target size of the processing server group depending on an evaluation index representing a local load observed for the processing servers in the processing server group.

12) The information processing apparatus according to claim 11, wherein
the target size calculating unit determines a bottleneck from the evaluation index observed for the processing servers in the processing server group and on condition that it is determined that the bottleneck is in a stage following the processing server group, calculates a target size of a second server group provided in the stage following the processing server group on the basis of the amount of traffic transferred to the processing server group and the amount of traffic transferred to the alternate server, and
the server preparation unit prepares processing servers in the second server group in order to increase the size of the second server group to the target size.

13) A method of scaling performed by an information processing apparatus connected to a load balancer, the load balancer distributing traffic among a plurality of processing servers in a processing server group while monitoring the state of load on the processing server group and transferring traffic to an alternate server on condition that the processing server group becomes overloaded, the method comprising the steps of:
the information processing apparatus detecting satisfaction of a scale-up trigger condition for increasing the size of the processing server group;
the information processing apparatus acquiring, from the load balancer, the amount of traffic transferred to the processing server group and the amount of traffic transferred to the alternate server;
the information processing apparatus calculating a target size of the processing server group on the basis of the amount of traffic transferred to the processing server group and the amount of traffic transferred to the alternate server; and
the information processing apparatus preparing the processing servers in the processing server group in order to increase the size of the processing server group to the target size.

14) The method of scaling according to claim 13, wherein the step of calculating the target size comprises the step of the information processing apparatus calculating the target size of the processing server group depending on an evaluation index representing a local load observed for the processing servers in the processing server group.

15) The method of scaling according to claim 14, further comprising the steps of:
the information processing apparatus determining a bottleneck from the evaluation index observed for the processing servers in the processing server group;
the information processing apparatus calculating on condition that it is determined that the bottleneck is in a stage following the processing server group, a target size of a second server group provided in the stage following the processing server group on the basis of the amount of traffic transferred to the processing server group and the amount of traffic transferred to the alternate server; and
the information processing apparatus preparing processing servers in the second server group in order to increase the size of the second server group to the target size.

16) A computer-executable program for causing a computer to function as:
a transfer amount acquisition unit acquiring, from a load balancer, the amount of traffic transferred to a processing server group and the amount of traffic transferred to an alternate server, the load balancer distributing traffic among a plurality of processing servers in the processing server group and transferring traffic to the alternate server on condition that the processing server group becomes overloaded;
a target size calculating unit calculating a target size of the processing server group on the basis of the amount of traffic transferred to the processing server group and the amount of traffic transferred to the alternate server; and
a server preparation unit preparing the processing servers in the processing server group in order to increase the size of the processing server group to the target size.

17) A recording medium having the computer-executable program according to claim 16 recorded thereon in computer-readable form.
